(19) United States
(12) Patent Application Publication
(10) Pub. No.: US 2011/0042326 A1
(43) Pub. Date: Feb. 24, 2011

(54) PHOTOCATALYTICALLY ACTIVE TIO2-MOLDED BODIES

(75) Inventors: Alexandra Seeber, Lambsheim (DE); Götz-Peter Schindler, Mannheim (DE); Katrin Freitag, Ludwigshafen (DE); Reinhard Hess, Ellerstadt (DE); Rudolf Piehl, Ludwigshafen-Ruchheim (DE); Thilo Hahn, Kirchheimbolanden (DE); Thomas Hill, Ludwigshafen (DE); Michael Hesse, Worms (DE); Piotr Makarczyk, Ludwigshafen (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/990,723

(22) PCT Filed: Apr. 30, 2009
(86) PCT No.: PCT/EP09/55247

§ 371 Date: Nov. 2, 2010

(30) Foreign Application Priority Data
May 2, 2008 (EP) 08155558.3

(51) Int. Cl. C02F 1/32

(52) U.S. Cl. 210/748.1

(57) ABSTRACT

The present invention relates to a method of purifying wastewater by contacting the wastewater which is to be purified with a rod-shaped TiO₂ photocatalyst which has a BET surface area of 25 to 200 m²/g, a pore volume of 0.10 to 1.00 ml/g, and a median pore diameter of 0.005 to 0.050 μm, with irradiation by light, and to the use of such a rod-shaped TiO₂ photocatalyst which has a BET surface area of 25 to 200 m²/g, a pore volume of 0.10 to 1.00 ml/g, and a median pore diameter of 0.005 to 0.050 μm, for purifying wastewater with irradiation by light.

The present invention relates to a method of purifying wastewater by contacting the wastewater which is to be purified with a rod-shaped TiO₂ photocatalyst with irradiation by light, and also the use of a rod-shaped TiO₂ photocatalyst for purifying wastewater with irradiation by light.

Titanium-dioxide-comprising photocatalysts and the use of such catalysts for wastewater purification are already described in the prior art.

CN 134 8834 discloses titanium-dioxide-comprising catalyst pellets having a BET surface area of 4 to 20 m²/g which can be used for purifying wastewater having organic impurities. The catalyst used according to CN 134 8834 is produced using a pore-forming reagent selected from carbon, starch and carbonate salts. CN 134 8834 does not disclose any method of purifying wastewater in which a rod-shaped TiO₂ photocatalyst having a BET surface area of 25 to 200 m²/g is used.

JP 2005/066433 discloses a photocatalytically active granule-comprising titanium dioxide in the anatase modification. According to JP 2005/066433, the granules used must have a minimum size of 0.5 to 1.0 millimeters in order to remain active over a long time period. Properties such as BET surface area, pore volume or median pore diameter of the titanium-dioxide-comprising granules used are not disclosed in JP 2005/066433.

JP 2000/354863 discloses a photocatalyst for wastewater treatment which comprises titanium dioxide as catalytically active compound. The wastewater which is to be treated can comprise organic impurities. JP 2000/354863 does not disclose any specifications of the titanium dioxide catalyst used.

EP 1 175 259 B1 discloses molded bodies of titanium dioxide, methods for production thereof, and use thereof. According to this document the molded bodies comprise titanium dioxide having a grain size of 0.01 to 50 mm which comprise in each case primary crystallites of titanium dioxide in the anatase modification and have a BET surface area of 20 to 150 m²/g, a pore volume of 0.1 to 0.45 cm³/g and a pore diameter of 100 to 300 Å. According to EP 1 175 259 B1 the fraction of foreign ions in these catalysts is particularly low. The molded bodies exhibit UV activity, and so they can be used as photocatalysts. EP 1 175 259 B1 does not disclose any method of purifying wastewater using these titanium dioxide catalysts.

US 2001/0006933 A1 discloses photocatalytically active granules and a method of production thereof. As photocatalytically active compound, titanium dioxide is present in these molded bodies, and at least 10% by weight of colloidal silicon dioxide is used as binder. US 2001/0006933 A1 does not disclose any properties of the titanium dioxide catalyst with respect to BET surface area, pore volume or pore diameter. In addition, no method of wastewater purification is disclosed.

EP 1 369 383 discloses a method of removing sulfur from a mixture comprising hydrogen sulfide and benzene, toluene and/or xylene. For this a catalyst is used which comprises a support that comprises at least one compound which is selected from the group consisting of aluminum, titanium dioxide and zirconium, wherein the support in addition comprises at least one doping element which is selected from the group consisting of iron, cobalt, nickel, copper and vanadium. EP 1 369 383 likewise does not disclose a method of purifying contaminated wastewater.

It is an object of the present invention to provide a method of purifying wastewater which is distinguished by a particularly high efficiency. For example, the method according to the invention should have a constantly high purifying action even over a relatively long time period. In addition, the method should effectively separate off the contaminating substances which are present in the wastewater in such a manner that a purified wastewater is obtained which has a particularly low content of pollutants.

These objects are achieved by a method of purifying wastewater by contacting the wastewater which is to be purified with a rod-shaped TiO₂ photocatalyst which has a BET surface area of 25 to 200 m²/g, a pore volume of 0.10 to 1.00 ml/g and a median pore diameter of 0.005 to 0.050 μm, with irradiation by light, and also by the use of such a rod-shaped photocatalyst for purifying wastewater with irradiation by light.

In the method according to the invention for purifying wastewater, a special rod-shaped titanium dioxide photocatalyst is used which is distinguished by the combination according to the invention of BET surface area, pore volume, median pore diameter, and geometry of the individual catalyst particles. This combination according to the invention gives a particularly high activity, and also a particularly long service life of the photocatalyst used with constantly high activity.

In a preferred embodiment of the method according to the invention, use is made of titanium dioxide which is present essentially in the anatase modification. “Essentially”, in the context of the present invention, means that at least 50%, particularly preferably at least 75%, of the titanium dioxide is in the anatase modification, based on the XRD measurement method known to those skilled in the art. The remainder of the titanium dioxide comprises amorphous metal oxide, brookite or rutile modification or a mixture thereof. In a very particularly preferred embodiment, the titanium dioxide used is completely, i.e. determined by XRD at 100%, in the anatase modification.

In the method according to the invention, a rod-shaped TiO₂ photocatalyst is used. Rod-shaped, in the context of the present invention, means that the photocatalyst used preferably has an oval or round base. The diameter of this round base or of an oval base in the greatest extension is generally 0.2 to 10 mm, preferably 0.5 to 3.0 mm. The rod-shaped titanium dioxide photocatalyst generally has a length of 0.5 to 10 mm, preferably 0.8 to 8 mm, particularly preferably 1.0 to 5.0 mm. This ratio of length to diameter of the rod-shaped photocatalyst according to the invention is generally 0.05 to 50, preferably 1.0 to 10.

The rod-shaped photocatalyst used comprises, as photocatalytically active material, essentially titanium dioxide, i.e. the photocatalyst used generally comprises at least 90% by weight, preferably at least 95% by weight, particularly preferably 99% by weight, titanium dioxide. The remainder is inorganic or organic additives, or a mixture thereof.

In a further preferred embodiment, the titanium dioxide photocatalyst comprises at least one additive, particularly preferably selected from groups 1, 4, 8, 9, 10, 11, 13, 14, 15 of the Periodic Table of the Elements (new IUPAC nomenclature) or the lanthanoids, for example selected from the group consisting of sodium, potassium, zirconium, cobalt, zinc, iron, copper, silver, gold, palladium, platinum, gallium, nitrogen, carbon, sulfur, ytterbium, erbium, thulium, neodymium and mixtures thereof, in elemental or in oxidic form. Preferably, combinations of two or more of said additives can also be present, particularly preferred combinations are zirconium and nitrogen, zirconium and cobalt, lanthanum and zirconium, potassium and zirconium, or sodium and zirconium.

The at least one additive is present in the rod-shaped titanium dioxide photocatalyst used according to the invention preferably in an amount of 0.001 to 5% by weight, particularly preferably 0.01 to 3% by weight. If two or more of said additives are present simultaneously in the photocatalyst used according to the invention, said quantities relate to this mixture.

The rod-shaped titanium dioxide photocatalyst used according to the invention generally has a BET surface area of 25 to 200 m²/g, preferably 50 to 180 m²/g, particularly preferably 80 to 150 m²/g. The BET surface area can be determined by methods known to those skilled in the art, for example as specified in DIN 66 131.

The rod-shaped titanium dioxide photocatalyst used according to the invention generally has a pore volume of 0.1 to 1.00 ml/g, preferably 0.2 to 0.7 ml/g, particularly preferably 0.25 to 0.55 ml/g. The pore volume can be determined by methods known to those skilled in the art.

The rod-shaped titanium dioxide photocatalyst which is usable according to the invention generally has a median pore diameter of 0.001 to 0.050 μm, preferably 0.005 to 0.030 μm, particularly preferably 0.010 to 0.025 μm. The median pore diameter can be determined by methods known to those skilled in the art.

The rod-shaped titanium dioxide photocatalyst which is usable according to the invention can be produced by methods known to those skilled in the art. In a preferred embodiment, the photocatalyst used according to the invention is obtained by mixing the corresponding amounts of titanium dioxide and at least one organic binder, preferably selected from sugar derivatives, for example tylose, starch solutions, for example edible starches, celluloses such as, for example, methyl cellulose, and/or at least one fatty acid, for example stearic acid, polymers such as, for example, poly(ethylene oxide) and at least one acid, for example mineral acid, such as dilute nitric acid or hydrochloric acid or organic acid such as formic acid. This mixture is mixed according to methods known to those skilled in the art in conventional apparatus, for example in an edge runner. The resultant mixture can then be extruded to form the corresponding rod-shaped photocatalysts. The extrudate thus produced is preferably dried at a temperature of at most 120° C., and the resultant rods are then calcined preferably at a temperature of 300 to 500° C. in an air atmosphere in order to obtain the combination according to the invention of BET surface area, pore volume and median pore diameter.

Especially the use of tylose and stearic acid in the production of the titanium dioxide which is used according to the invention has the effect that the resultant titanium dioxide has the combination according to the invention of high activity and high stability having enduring high activity over a long time period.

By means of the method according to the invention it is possible to purify wastewater in which interfering and/or toxic substances are present. By means of the method according to the invention the wastewater is purified, i.e., after the method the concentration of interfering substances is lower than before the method. In the context of the present invention, the wastewater which is to be treated can for example be from industrial plants, for example oil refineries, papermaking factories, mines, in the food sector or in the chemical industry, the private sphere, for example sports facilities, restaurants, hospitals, or of natural origin. Generally, the interfering substances which must be removed from the wastewater are selected from organic or inorganic substances which, if they were to remain in the wastewater, develop an interfering activity, for example by a toxic activity, odor nuisance, coloring of the wastewater, etc.

In a preferred embodiment of the method according to the invention, the purification proceeds by chemical decomposition of organic or inorganic compounds for example organic acids, halogenated organic substances, aromatic or aliphatic organic substances, amines, oligomeric or polymeric materials, alcohols, ethers, esters, sugars, biodegradable or non-biodegradable substances, surfactants, ammonia, salts, heavy metals and mixtures thereof.

Preferably, the substances which can be removed from the wastewater by the method according to the invention are selected from organic compounds selected from the group consisting of organic acids, halogenated organic substances, aromatic or aliphatic organic substances, amines, oligomeric or polymeric materials, alcohols, ethers, esters, sugars, biodegradable or non-biodegradable substances, surfactants, and mixtures thereof.

The method according to the invention for purifying wastewater is carried out by contacting the rod-shaped titanium dioxide photocatalyst with the wastewater which is to be purified. This contacting can be carried out continuously or discontinuously. Suitable apparatus are known to those skilled in the art, for example fixed-bed reactors such as flow tubes or plate reactors.

In a preferred embodiment, the rod-shaped titanium dioxide photocatalyst is placed in a corresponding vessel, for example a flow tube, and the wastewater which is to be purified flows over and/or through this catalyst. The flow velocity of the wastewater which is to be purified must be adjusted in this case such that a sufficiently long contact time between the wastewater which is to be purified and the photocatalyst exists. A suitable flow velocity is, for example, 0.001 to 100 cm/s, preferably 0.01 to 1 cm/s.

The method according to the invention is carried out at a temperature of generally 0 to 80° C., preferably 10 to 60° C., particularly preferably 15 to 35° C. The method according to the invention is generally carried out at a pressure of 0.5 to 50 bar, preferably 0.8 to 5 bar, particularly preferably at atmospheric pressure.

In the method according to the invention, the titanium dioxide photocatalyst has a particularly high long-term stability. The activity of the catalyst is proportional to the decomposition rate which is measured in “amount of pollutant decomposed per unit time per amount of catalyst”. The activity of the catalyst depends on the pollutant which is to be decomposed, and also on the reaction conditions, for example temperature, concentrations etc.

The stability of the catalyst can be determined by comparing the activity, of the catalyst after a reaction time x with the activity₀ of the catalyst at the time point 0, i.e. at the start of the reaction. Suitable reaction times x are, for example, 12, 24, or 36 months. The photocatalyst according to the invention, for example after a reaction time of 12 months, preferably after 24 months, particularly preferably after 36 months, still has an activity, which is at least 80%, preferably at least 90%, particular preferably at least 95%, of the activity₀. Therefore, the catalyst according to the invention scarcely loses activity over a long time period, which qualifies it particularly for continuous and low-maintenance purification methods.

The method according to the invention comprises contacting the wastewater which is to be purified with a rod-shaped titanium dioxide photocatalyst with irradiation by light.

According to the invention, any type of light which is known to those skilled in the art can be used, for example light having a wavelength λ of 200 to 800 nm, preferably 300 to 500 nm, very particularly preferably 360 to 420 nm. It is, for example, possible according to the invention that the method according to the invention is carried out using UV light (λ=200 to 400 nm), daylight (λ=380 to 800 nm), and/or the light of a commercially available incandescent lamp (λ=400 to 800 nm).

The light intensity with which the irradiation with light proceeds is generally 0.01 to 100 mW/cm², preferably 0.1 to 20 mW/cm².

The present invention also relates to the use of a rod-shaped TiO₂ photocatalyst which has a BET surface area of 25 to 200 m²/g, a pore volume of 0.10 to 1.00 ml/g, and a median pore diameter of 0.005 to 0.050 μm, for purifying wastewater with irradiation by light.

With respect to the use of the specific rod-shaped titanium dioxide photocatalyst for purifying wastewater and the preferred embodiments, that stated with regard to the method according to the invention applies.

In particular, in the use according to the invention, the TiO₂ photocatalyst comprises at least one additive selected from groups 1, 4, 8, 9, 10, 11, 13, 14, 15 of the Periodic Table of the Elements (new IUPAC nomenclature) or the lanthanoids.

Preferably the at least one additive is present in an amount of 0.01 to 5% by weight, based on the TiO₂ photocatalyst.

In addition, a use according to the invention is preferred wherein the wastewater which is to be purified comprises organic or inorganic compounds, preferably from the group consisting of organic acids, halogenated organic substances, aromatic or aliphatic organic substances, amines, oligomeric or polymeric materials, alcohols, ethers, esters, sugars, biodegradable or non-biodegradable substances, surfactants, ammonia, salts, heavy metals and mixtures thereof.

### EXAMPLES

### Example 1

### 1.5 mm TiO₂ Tablets (Comparative Example)

11.2 kg of TiO₂ (S150, FinnTi, from Kemira) are mixed with ascorbyl palmitate (3%) and pressed into a tablet shape (1.5×1.5 mm). The tablets are calcined for 3 hours at 500° C.

### Example 2

### 3 mm TiO₂ Tablets (Comparative Example)

11.2 kg of TiO₂ (S150, FinnTi, from Kemira) are mixed with ascorbyl palmitate (3%) and pressed into a tablet shape (3×3 mm). The tablets are calcined for 3 hours at 500° C.

### Example 3

### 5 mm TiO₂ Tablets (Comparative Example)

4.04 kg of TiO₂ (S150, FinnTi, from Kemira) are mixed with ascorbyl palmitate (3%) and pressed into a tablet shape (5×5 mm). The tablets are calcined over 3 hours at 500° C.

### Example 4

### 2 mm TiO₂— Coated Al₂O₃ Beads (Comparative Example)

60 g of Al₂O₃ beads (from Sasoll, 2.0 mm diameter, ignited at 1300° C.) are impregnated in 20 ml of titanium isopropoxide and dried over 4 h in air at room temperature. The almost dried beads are then heated to 120° C. in a muffle furnace in 30 min and predried for 2 h at 120° C. The beads are subsequently heated to 500° C. in 75 min and calcined for 1 h at 500° C.

TABLE 1

| | BET | | Median | | Photocatalytic | |
|---|---|---|---|---|---|---|
| | surface | Pore | pore | Photocatalytic | activity | Photocatalytic |
| | area | volume | diameter | activity | after 8 months | stability [%] |
| Example | [m²/g] | [ml/g] | [μm] | [ppm/h * kg of cat.] | [ppm/h * kg of cat.] | after 8 months |
| 1 | 50.2 | 0.16 | 0.018 | 125 | — | — |
| 2 | 26.0 | 0.21 | 0.043 | 132 | 122 | 92.4 |
| 3 | 30.2 | 0.29 | 0.062 | 164 | — | — |
| 4 | — | — | — | 110 | 85 | 77.3 |

The photoactivities are determined according to example 35.

### Example 5

### 1.5 mm Rods (According to the Invention)

A TiO₂ photocatalyst according to the invention is produced as follows:

200 kg of TiO₂, 40 kg of grinding material (REUGEM), 1.04 kg of tylose and 2 kg of stearic acid are dried and premixed for 5 minutes. 82 l of dilute nitric acid are run in slowly (over 15 min). In the last 10 minutes, the moisture is adjusted using a max. 7 l of deionized water. Subsequently the material is mixed in an edge runner for 60 minutes.

For the extrusion, 1.5 mm dies are used, and a one-armed wiper is used, such that the wiper arm is opposite the end of the screw flight. A torque of 50-150 Nm is set. The extruder is cooled. The resultant extrudates are dried in a three zone drier at 55/70/100° C. in zone 1/2/3. The dried extrudates are calcined in a multizone furnace at 300° C. (zone 1)/300° C. (zone 2)/435° C. (zone 3)/435° C. (zone 4)/435° C. (zone 4).

The resultant rod-shaped catalyst has the following properties.

TABLE 2

| | BET | | Median | | Photocatalytic | |
|---|---|---|---|---|---|---|
| | surface | Pore | pore | Photocatalytic | activity after | Photocatalytic |
| | area | volume | diameter | activity | 8 months | stability [%] |
| Example | [m²/g] | [ml/g] | [μm] | [ppm/h * kg of cat.] | [ppm/h * kg of cat.] | after 8 months |
| 5 | 116 | 0.33 | 0.017 | 182 | 182 | 100 |

The photoactivities are determined according to example 35.

In addition, the photoactivity of the product was determined according to example 33 (4074 ppm/h*kg_{CATALYST}) and example 34 (943 ppm/h*kg_{CATALYST}).

### Example 6

### Improvement of Hardness and Increase of Bet Surface Area

There is a correlation between the rod hardness and the specific surface area of the support. A harder rod has a lower surface area. These properties are set by the temperature in the calcining zone of the calcination. At a higher temperature the hardness increases, but the surface area becomes smaller. The window for operating the furnace is, in the hot zone, between 420 and 435° C.

The above mentioned data are an optimized operating point.

### Example 7

### Modification of the TiO₂ Rods with Yttrium (According to the Invention)

2 mmol of yttrium nitrate are dissolved in 20 ml of water, and 20 g of 1.5 mm TiO₂ rods from example 5 are impregnated therewith (excess solution is decanted off). The rods are predried in a circulating air furnace to 120° C. over 30 min and at 120° C. for 2 h and then calcined to 500° C. over 76 min and at 500° C. for 1 h. The Y content is 0.41 g/100 g.

The photocatalytic activity is determined as described in example 33. The product has a DCA decomposition rate of 4141 ppm/h*kg of catalyst.

### Example 8

### Modification of the TiO₂ Rods with Erbium (According to the Invention)

2 mmol of erbium nitrate are dissolved in 20 ml of water, and 20 g of 1.5 mm TiO₂ rods from example 5 are impregnated therewith (excess solution is decanted off). The rods are predried in a circulating air furnace to 120° C. over 30 min and at 120° C. for 2 h and then calcined to 500° C. over 76 min and at 500° C. for 1 h. The Er content is 1.0 g/100 g.

The photocatalytic activity is determined as described in example 33. The product has a DCA decomposition rate of 4208 ppm/h*kg of catalyst.

### Example 9

### Modification of the TiO₂ Rods with Thulium (According to the Invention)

2 mmol of thulium nitrate are dissolved in 20 ml of water, and 20 g of 1.5 mm TiO₂ rods from example 5 are impregnated therewith (excess solution is decanted off). The rods are predried in a circulating air furnace to 120° C. over 30 min and at 120° C. for 2 h and then calcined to 500° C. over 76 min and at 500° C. for 1 h. The Tm content is 0.86 g/100 g.

The photocatalytic activity is determined as described in example 33. The product has a DCA decomposition rate of 4259 ppm/h*kg of catalyst.

### Example 10

### Modification of the TiO₂ Rods with Gallium (According to the Invention)

2 mmol of gallium nitrate are dissolved in 20 ml of water, and 20 g of 1.5 mm TiO₂ rods from example 5 are impregnated therewith (excess solution is decanted off). The rods are predried in a circulating air furnace to 120° C. over 30 min and at 120° C. for 2 h and then calcined to 500° C. over 76 min and at 500° C. for 1 h. The Ga content is 0.40 g/100 g.

The photocatalytic activity is determined as described in example 33. The product has a DCA decomposition rate of 4394 ppm/h*kg of catalyst.

### Example 11

### Modification of the TiO₂ Rods with Neodymium (According to the Invention)

2 mmol of neodymium nitrate are dissolved in 20 ml of water, and 20 g of 1.5 mm TiO₂ rods from example 5 are impregnated therewith (excess solution is decanted off). The rods are predried in a circulating air furnace to 120° C. over 30 min and at 120° C. for 2 h and then calcined to 500° C. over 76 min and at 500° C. for 1 h. The Nd content is 0.78 g/100 g.

The photocatalytic activity is determined as described in example 33. The product has a DCA decomposition rate of 4427 ppm/h*kg of catalyst.

### Example 12

### Modification of the TiO₂ Rods with Zirconium and Nitrogen (According to the Invention)

20 g of the TiO₂ rods from example 15 are charged into a rotary kiln and heated to 450° C. in 1 h with 7.0 l/h of NH₃. Then the rods are kept at 450° C. over 3 h and thereafter cooled under N₂. The product is light yellow. The Zr content is 0.16%, the N content is 0.017%.

The photocatalytic activity is determined as described in example 33. The product has a DCA decomposition rate of 5016 ppm/h*kg of catalyst.

### Example 13

### Modification of the TiO₂ Rods with Zirconium and Nitrogen (According to the Invention)

20 g of the TiO₂ rods from example 15 are charged into a rotary kiln and heated to 400° C. in 1 h with 7.0 l/h of NH₃. Then the rods are kept at 400° C. over 3 h and thereafter cooled under N₂. The product is light yellow. The Zr content is 0.16%, the N content is 0.016%.

The photocatalytic activity is determined as described in example 33. The product has a DCA decomposition rate of 5218 ppm/h*kg of catalyst.

### Example 14

### Modification of the TiO₂ Rods with Nitrogen (According to the Invention)

50 g of the uncalcined TiO₂ rods from example 5 are charged into a rotary kiln and heated to 550° C. in 1 h with 7.5 l/h of NH₃. Then the rods are kept at 550° C. over 3 h and thereafter cooled under N₂. The product is gray. The N content is 0.002%.

The photocatalytic activity is determined as described in example 33. The product has a DCA decomposition rate of 5538 ppm/h*kg of catalyst.

### Example 15

### Modification of the TiO₂ Rods with Zirconium (According to the Invention)

9.3 g of zirconium nitrate (40 mmol) are dissolved in 400 ml of water and 400 g of 1.5 mm TiO₂ rods from example 5 are impregnated therewith (excess solution is decanted off). After 6 hours the rods are dried at 80° C. for 16 h by circulating air. The almost dried rods are heated to 300° C. in 2 h and calcined at 300° C. for 3 h. The Zr content is 0.16%.

The photocatalytic activity is determined as described in example 33. The product has a DCA decomposition rate of 5723 ppm/h*kg of catalyst. In addition, the photocatalytic activity is determined as described in example 34. The product has a DCA decomposition rate of 1044 ppm/h*kg of catalyst.

### Example 16

### Modification of the TiO₂ Rods with Nitrogen (According to the Invention)

20 g of the uncalcined TiO₂ rods from example 5 are charged into a rotary kiln and heated to 500° C. in 1 h with 7.5 l/h of NH₃. Then the rods are held at 500° C. over 3 h in NH₃ and calcined at 500° C. over 3 h in air and cooled. The product is light yellow. The N content is 0.002%.

The photocatalytic activity is determined as described in example 33. The product has a DCA decomposition rate of 5841 ppm/h*kg of catalyst.

### Example 17

### Modification of the TiO₂ Rods with Sodium (According to the Invention)

2 mmol of sodium nitrate are dissolved in 20 ml of water and 20 g of 1.5 mm TiO₂ rods from example 5 are impregnated therewith (excess solution is decanted off). The rods are predried in a circulating air furnace to 120° C. over 30 min and at 120° C. for 2 h and then calcined to 500° C. over 76 min and at 500° C. for 1 h. The Na content is 0.16 g/100 g.

The photocatalytic activity is determined as described in example 33. The product has a DCA decomposition rate of 5909 ppm/h*kg of catalyst.

### Example 18

### Modification of the TiO₂ Rods with Silver (According to the Invention)

2 mmol of silver nitrate are dissolved in 20 ml of water, and 20 g of 1.5 mm TiO₂ rods from example 5 are impregnated therewith (excess solution is decanted off). The rods are predried in a circulating air furnace to 120° C. over 30 min and at 120° C. for 2 h and then calcined to 500° C. over 76 min and at 500° C. for 1 h. The Ag content is 0.93 g/100 g.

The photocatalytic activity is determined as described in example 33. The product has a DCA decomposition rate of 5959 ppm/h*kg of catalyst.

### Example 19

### Modification of the TiO₂ Rods with Nitrogen (According to the Invention)

20 g of the TiO₂ rods from example 5 are charged into a rotary kiln and heated to 500° C. in 1 h with 7.5 l/h of NH₃. Then the rods are held at 500° C. over 2 h in NH₃ and calcined at 500° C. over 3 h in air and cooled. The product is light yellow. The N content is 0.002%.

The photocatalytic activity is determined as described in example 33. The product has a DCA decomposition rate of 6363 ppm/h*kg of catalyst.

### Example 20

### Modification of the TiO₂ Rods with Zirconium and Cobalt (According to the Invention)

9.3 g of zirconium nitrate (40 mmol) are dissolved in 400 ml of water, and 400 g of 1.5 mm TiO₂ rods from example 5 are impregnated therewith (excess solution is decanted off). After 6 hours the rods are dried at 80° C. for 16 h by circulating air. The almost dried rods are heated to 300° C. in 2 h and calcined at 300° C. for 3 h. 20 g of these rods are impregnated in a solution of 0.58 g of cobalt nitrate and 19.4 g of water. The rods are dried at 80° C. over 16 h by circulating air. The almost dried rods are heated to 300° C. in 2 h and calcined at 300° C. for 3 h. The Zr content is 0.28% and the Co content is 0.33%.

The photocatalytic activity is determined as described in example 33. The product has a DCA decomposition rate of 6565 ppm/h*kg of catalyst.

### Example 21

### Modification of the TiO₂ Rods with Lanthanum and Zirconium (According to the Invention)

20 g of the TiO₂ rods from example 5 are impregnated in a solution of 0.87 g of lanthanum nitrate and 19.1 g of water. The rods are dried at 80° C. over 16 h by circulating air. The almost dried rods are heated to 300° C. in 2 h and calcined at 300° C. for 3 h. These calcined rods are impregnated in a solution of 0.46 g of zirconium nitrate and 19.5 g of water. The rods are dried at 80° C. over 16 h by circulating air. The almost dried rods are heated to 300° C. in 2 h and calcined at 300° C. for 3 h.

The photocatalytic activity is determined as described in example 33. The product has a DCA decomposition rate of 6599 ppm/h*kg of catalyst.

### Example 22

### Modification of the TiO₂ Rods with Potassium and Zirconium (According to the Invention)

20 g of the TiO₂ rods from example 5 are impregnated in a solution of 0.20 g of potassium nitrate and 19.8 g of water. The rods are dried at 80° C. over 16 h by circulating air. The almost dried rods are heated to 300° C. in 2 h and calcined at 300° C. for 3 h. These calcined rods are impregnated in a solution of 0.46 g of zirconium nitrate and 19.5 g of water. The rods are dried at 80° C. over 16 h by circulating air. The almost dried rods are heated to 300° C. in 2 h and calcined at 300° C. for 3 h. The Zr content is 0.34% and the K content is 0.28%.

The photocatalytic activity is determined as described in example 33. The product has a DCA decomposition rate of 6868 ppm/h*kg of catalyst.

### Example 23

### Modification of the TiO₂ Rods with Zirconium and Potassium (According to the Invention)

9.3 g of zirconium nitrate (40 mmol) are dissolved in 400 ml of water, and 400 g of 1.5 mm TiO₂ rods from example 5 are impregnated therewith (excess solution is decanted off). After 6 hours the rods are dried at 80° C. for 16 h by circulating air. The almost dried rods are heated to 300° C. in 2 h and calcined at 300° C. for 3 h. 20 g of these rods are impregnated in a solution of 0.20 g of potassium nitrate and 19.8 g of water. The rods are dried at 80° C. over 16 h by circulating air. The almost dried rods are heated to 300° C. in 2 h and calcined at 300° C. for 3 h. The Zr content is 0.29% and the K content is 0.26%.

The photocatalytic activity is determined as described in example 33. The product has a DCA decomposition rate of 7945 ppm/h*kg of catalyst.

### Example 24

### Modification of the TiO₂ Rods with Sodium and Zirconium (According to the Invention)

20 g of TiO₂ rods from example 5 are impregnated in a solution of 0.17 g of sodium nitrate, 0.46 g of zirconium nitrate and 19.3 g of water. The rods are dried at 80° C. over 16 h by circulating air. The almost dried rods are heated to 300° C. in 2 h and calcined at 300° C. for 3 h.

The photocatalytic activity is determined as described in example 33. The product has a DCA decomposition rate of 7996 ppm/h*kg of catalyst.

### Example 25

### Modification of the TiO₂ Rods: Sodium and Zirconium (According to the Invention)

20 g of TiO₂ rods from example 5 are impregnated in a solution of 0.17 g of sodium nitrate and 19.8 g of water. The rods are dried at 80° C. over 16 h by circulating air. The almost dried rods are heated to 300° C. in 2 h and calcined at 300° C. for 3 h. These calcined rods are impregnated in a solution of 0.46 g of zirconium nitrate and 19.5 g of water. The rods are dried at 80° C. over 16 h by circulating air. The almost dried rods are heated to 300° C. in 2 h and calcined at 300° C. for 3 h. The Zr content is 0.32% and the Na content is 0.13%.

The photocatalytic activity is determined as described in example 33. The product has a DCA decomposition rate of 8484 ppm/h*kg of catalyst.

### Example 26

### Modification of the TiO₂ Rods with Lanthanum and Zirconium (According to the Invention)

20 g of TiO₂ rods from example 5 are impregnated in a solution of 0.87 g of lanthanum nitrate, 0.46 g of zirconium nitrate and 18.7 g of water. The rods are dried at 80° C. over 16 h by circulating air. The almost dried rods are heated to 300° C. in 2 h and calcined at 300° C. for 3 h. The Zr content is 0.37% and the La content is 0.83%.

The photocatalytic activity is determined as described in example 33. The product has a DCA decomposition rate of 8686 ppm/h*kg of catalyst.

### Example 27

### Production of Zr-Doped 1.5 mm TiO₂ Rods (According to the Invention)

200 kg of TiO₂, 0.0176 kg of ZrO(NO₃)₂, 40 kg of grinding material (REUGEM), 1.04 kg of tylose and 2 kg of stearic acid are dried and premixed for 5 minutes. 82 l of dilute nitric acid are run in slowly (over 15 min). In the last 10 minutes, the moisture is adjusted using a max. 7 l of deionized water. Subsequently the mixture is mixed in an edge runner for 60 minutes.

For the extrusion, 1.5 mm dies are used, a one-armed wiper is used, such that the wiper arm is opposite the end of the screw flight. A torque of 50-150 Nm is set. The extruder is cooled. The resultant extrudates are dried in a three-zone drier, 55/70/100° C. in zone 1/2/3. The dried extrudates are calcined in a rotary kiln furnace at 435° C. The Zr content is 0.08%.

The photocatalytic activity of the 1.5 mm TiO₂ rods is determined by the method in example 35. The 1.5 mm TiO₂ rods have a DCA decomposition rate of 233 ppm/h*kg of catalyst.

### Example 28

### Production of Zr-Doped 1.5 mm TiO₂ Rods

200 kg of TiO₂, 0.0352 kg of ZrO(NO₃)₂, 40 kg of grinding material (REUGEM), 1.04 kg of tylose and 2 kg of stearic acid are dried and premixed for 5 minutes. 82 l of dilute nitric acid are run in slowly (over 15 min). In the last 10 minutes, the moisture is adjusted using a max. 7 l of deionized water. Subsequently the mixture is mixed in an edge runner for 60 minutes.

For the extrusion, 1.5 mm dies are used, a one-armed wiper is used, such that the wiper arm is opposite the end of the screw flight. A torque of 50-150 Nm is set. The extruder is cooled. The resultant extrudates are dried in a three-zone drier, 55/70/100° C. in zone 1/2/3. The dried extrudates are calcined in a rotary kiln furnace at 435° C. The Zr content is 0.16%.

The photocatalytic activity of the 1.5 mm TiO₂ rods is determined by the method in example 35. The 1.5 mm TiO₂ rods have a DCA decomposition rate of 250 ppm/h*kg of catalyst.

### Example 31

### Production of Zr-Doped 1.5 mm TiO₂ Rods

200 kg of TiO₂, 0.088 kg of ZrO(NO₃)₂, 40 kg of grinding material (REUGEM), 1.04 kg of tylose and 2 kg of stearic acid are dried and premixed for 5 minutes. 82 l of dilute nitric acid are run in slowly (over 15 min). In the last 10 minutes, the moisture is adjusted using a max. 7 l of deionized water. Subsequently the mixture is mixed in an edge runner for 60 minutes.

For the extrusion, 1.5 mm dies are used, a one-armed wiper is used, such that the wiper arm is opposite the end of the screw flight. A torque of 50-150 Nm is set. The extruder is cooled. The resultant extrudates are dried in a three-zone drier, 55/70/100° C. in zone 1/2/3. The dried extrudates are calcined in a rotary kiln furnace at 435° C. The Zr content is 0.49%.

The photocatalytic activity of the 1.5 mm TiO₂ rods is determined by the method in example 35. The 1.5 mm TiO₂ rods have a DCA decomposition rate of 238 ppm/h*kg of catalyst.

### Example 32

### Production of 3 mm TiO₂ Rods

200 kg of TiO₂, 40 kg of grinding material (REUGEM), 1.04 kg of tylose and 2 kg of stearic acid are dried and premixed for 5 minutes. 82 l of dilute nitric acid are run in slowly (over 15 min). In the last 10 minutes, the moisture is adjusted using a max. 7 l of deionized water. Subsequently the mixture is mixed in an edge runner for 60 minutes.

For the extrusion, 3.0 mm dies are used, a one-armed wiper is used, such that the wiper arm is opposite the end of the screw flight. A torque of 50-150 Nm is set. The extruder is cooled. The resultant extrudates are dried in a three-zone drier, 55/70/100° C. in zone 1/2/3. The dried extrudates are calcined at 435° C.

TABLE 3

| | | Pore | Median pore | Photo-catalytic |
|---|---|---|---|---|
| | BET surface | volume | diameter | activity |
| Example | area [m²/g] | [ml/g] | [μm] | [ppm/h*kg of cat.] |
| 32 | 85.6 | 0.34 | 0.018 | 217 |

Photoactivity is determined in accordance with example 35.

### Example 33

### Determination of Photocatalytic Activity with UV Irradiation

The photoactivities of the catalysts produced are determined by the rate of photocatalytic decomposition of the chlorinated hydrocarbon dichloroacetic acid (DCA) in suspension.

The total running time of the experiments for investigating the rate of photocatalytic decomposition of DCA with UV irradiation in aqueous solution is 24 hours. The UV light intensity is 1 mW/cm².

The pH of the solution is adjusted to 3 using sodium hydroxide solution. The temperature in the reactor is 20 to 30° C. The concentration of DCA is 20 mmol/l, and the concentration of the photocatalyst is 3 g/l. The decomposition rate (ppm/h) may be determined by determining the pH after 24 hours.

Blank experiments are carried out on the decomposition of DCA with irradiation with addition of a standard photocatalyst (Degussa P25, approximately 80% anatase/20% rutile modification, determined via XRD (diffractometer D 4 Endeavor)). In addition, blank experiments on the decomposition of DCA with UV irradiation without addition of photocatalysts and with rutile modification titanium dioxide (Degussa P25, calcined for 18 h at 900° C., 100% rutile fraction, determined via XRD (diffractometer D 4 Endeavor)).

TABLE 4

| | | Decomposition rate |
|---|---|---|
| | Catalyst | [ppm TOC/h] |
| Blank experiment 1 | none | 0 |
| Blank experiment 2 | rutile | 0 |
| Blank experiment 3 | P 25 | 4.34 |

TOC means “Total Organic Carbon”

### Example 34

### Determination of Photocatalytic Activity with Interior Irradiation

The photoactivities of the catalysts produced are determined by the rate of photocatalytic decomposition of the chlorinated hydrocarbon dichloroacetic acid (DCA) in suspension.

The total running time of the experiments for investigating the rate of photocatalytic decomposition of DCA with UV irradiation in aqueous solution is 24 hours. The irradiation proceeds using an Osram Biolux (L18/W965) lamp; the UV light intensity is <0.1 mW/cm².

The pH of the solution is adjusted to 3 using sodium hydroxide solution. The temperature in the reactor is 20 to 30° C. The concentration of DCA is 20 mmol/l, and the concentration of the photocatalyst is 3 g/l. The decomposition rate (ppm/h) may be determined by determining the pH after 24 hours.

### Example 35

### Determination of Photocatalytic Activity of Molded Body Catalysts

The photoactivities of the catalysts produced are determined by the rate of photocatalytic decomposition of the chlorinated hydrocarbon dichloroacetic acid (DCA) in suspension.

The total running time of the experiments for investigating the rate of photocatalytic decomposition of DCA with UV irradiation in aqueous solution is 6 hours. The irradiation proceeds using an Osram Biolux (L18/W965) lamp; the UV light intensity is 1.2 mW/cm².

The temperature in the reactor is 20 to 30° C. The concentration of DCA is 162 ppm. The pH of the DCA solution is adjusted to 3 using sodium hydroxide solution. 200 g of photocatalyst molded bodies are prepared. By titration of sodium hydroxide solution the pH is maintained at 3. The decomposition rate (ppm/h) is determined from the amount of sodium hydroxide solution added.

1.-9. (canceled)

10. A method of purifying wastewater by contacting the wastewater which is to be purified with a rod-shaped TiO₂ photocatalyst which has a BET surface area of 25 to 200 m²/g, a pore volume of 0.10 to 1.00 ml/g, and a median pore diameter of 0.005 to 0.050 μm, with irradiation by light.

11. The method according to claim 10, wherein the TiO₂ photocatalyst comprises at least one additive selected from groups 1, 4, 8, 9, 10, 11, 13, 14, 15 of the Periodic Table of the Elements (new IUPAC nomenclature) or the lanthanoids.

12. The method according to claim 10, wherein the method is carried out at a temperature of 0 to 80° C.

13. The method according to claim 10, wherein the purification proceeds by chemical decomposition of organic or inorganic compounds selected from organic acids, halogenated organic substances, aromatic or aliphatic organic substances, amines, oligomeric or polymeric materials, alcohols, ethers, esters, sugars, biodegradable or non-biodegradable substances, surfactants, ammonia, salts, heavy metals and mixtures thereof.

14. The method according to claim 11, wherein the at least one additive is present in an amount of 0.001 to 5% by weight.

15. The method according to claim 11, wherein the at least one additive is present in an amount of 0.01 to 3% by weight.

16. The method according to claim 11, wherein the rod-shaped TiO₂ photocatalyst which has a BET surface area of 50 to 180 m²/g, a pore volume of 0.20 to 0.7 ml/g, and a median pore diameter of 0.005 to 0.030 μm, with irradiation by light.

17. The method according to claim 11, wherein the rod-shaped TiO₂ photocatalyst which has a BET surface area of 80 to 150 m²/g, a pore volume of 0.25 to 0.55 ml/g, and a median pore diameter of 0.010 to 0.025 μm, with irradiation by light.

18. A method of using a rod-shaped TiO₂ photocatalyst which has a BET surface area of 25 to 200 m²/g, a pore volume of 0.10 to 1.00 ml/g, and a median pore diameter of 0.005 to 0.050 μm, for purifying wastewater with irradiation by light.

19. The method according to claim 18, wherein the TiO₂ photocatalyst comprises at least one additive selected from groups 1, 4, 8, 9, 10, 11, 13, 14, 15 of the Periodic Table of the Elements (new IUPAC nomenclature) or the lanthanoids.

20. The method according to claim 19, wherein the at least one additive is present in an amount of 0.01 to 5% by weight, based on the TiO₂ photocatalyst.

21. The method according to claim 18, wherein the wastewater which is to be purified comprises compounds selected from the group consisting of organic acids, halogenated organic substances, aromatic or aliphatic organic substances, amines, oligomeric or polymeric materials, alcohols, ethers, esters, sugars, biodegradable or non-biodegradable substances, surfactants, ammonia, salts, heavy metals and mixtures thereof.
